(19) United States
(12) Patent Application Publication
(10) Pub. No.: US 2004/0102308 A1
(43) Pub. Date: May 27, 2004

(54) Crucible material and crucible

(76) Inventors: Robert E. Simpson, Twin Lake, MI (US); Matthew W. Willer, Tucson, AZ (US); Alfred P. Kaulius, Muskegon, MI (US)

Correspondence Address: ECKERT SEAMANS CHERIN & MELOTTT, LLC, ALCOA TECHNICAL CENTER, 100 TECHNICAL CENTER DRIVE, ALCOA CENTER, PA, 15069-0001, US

(21) Appl. No.: 10/290,101

(22) Filed: Nov. 6, 2002

(51) Int. Cl. C04B 35/48

(52) U.S. Cl. 501/104; 428/34.4

(57) ABSTRACT

A crucible material whose chemical composition consists essentially of, in weight %, about 93.5% to about 97.5% ZrO₂, about 0.2% to about 1.0% MgO, about 1.0% to about 3.0% SiO₂, and about 1.5% to about 2.5% Y₂O₃ wherein the SiO₂ can be present as silica and a silicate of zirconium, magnesium, and/or yttrium. When formed to a crucible shape and sintered (fired) at elevated temperature, the ceramic material provides a crucible with improved resistance to thermal shock when heated to over 1100 degrees C.

### FIELD OF THE INVENTION

The present invention relates to crucibles for melting or holding a molten metal or alloy and, more particularly, to a ceramic crucible material for making crucibles.

### BACKGROUND OF THE INVENTION

Ceramic crucibles are known in the metal casting art for melting or holding a molten metal or alloy. An induction melting crucible typically includes a ceramic crucible around which an induction coil is disposed to heat and melt a solid metal or alloy charge. Holding or transfer crucibles are used to hold molten metal or alloy for a next operation, such as pouring, or to carry molten metal or alloy from one location to another. The ceramic crucible material typically comprises a mixture of ceramic components including a stabilizing component present to react with and at least partially stabilize a primary ceramic component of the mixture to reduce thermally-induced volume changes when the crucible is heated. For example, monoclinic zirconia (ZrO₂) undergoes a phase change at about 1000 degrees C., which produces a large volume change in the material. This volume change often causes cracks within a ZrO₂ crucible. In the past, a stabilizing agent, such as MgO or Y₂O₃, has been included with the ZrO₂ to stabilize the monoclinic phase such that the phase change occurs over a much wider range of temperatures so as to reduce stresses in the crucible.

Ceramic crucibles for use in melting or holding molten metals and alloys are subjected to considerable thermal shock as a result of the melting of a metal or alloy in the crucible or introduction of a molten metal or alloy in the crucible over a relatively short time. Thermal shock of the crucible can cause crucible cracking and spallation, reducing the useful life of the crucible. Increasing the thermal shock resistance of the ceramic melting crucible will improve its useful life in melting metal and alloys.

### SUMMARY OF THE INVENTION

The present invention provides in one embodiment a zirconia-based crucible material that includes, before sintering or firing, a combination of MgO, SiO₂, and Y₂O₃ in selected amounts to impart improved thermal shock resistance to a sintered or fired crucible made of the material.

An illustrative embodiment of the invention provides a crucible material whose chemical composition consists essentially of, in weight %, about 93.5% to about 97.5% ZrO₂, about 0.2% to about 1.0% MgO, about 1.0% to about 3.0% SiO₂, and about 1.5% to about 2.5% Y₂O₃ wherein the SiO₂ is selected from the group consisting of silica, a silicate of zirconium, a silicate of magnesium, and a silicate of yttrium and combinations thereof. The crucible material comprises, before sintering, a mixture of dry ceramic particles where a majority of the ZrO₂ particles preferably has a particle diameter size of about 44 microns and greater. The MgO (magnesia) particles, SiO₂-bearing particles, and Y₂O₃ (yttria) particles preferably are each present as particles of less than about 44 microns particle diameter size. When formed to a crucible shape and sintered (fired) at high temperature (e.g. above 1650 degrees C.), the ceramic material provides a fired ceramic crucible with improved resistance to thermal shock when heated in use for melting a metal or alloy to over 1100 degrees C.

The above and other advantages of the present invention will become more readily apparent from the following drawings taken in conjunction with the following detailed description.

### DESCRIPTION OF THE INVENTION

The present invention provides a zirconia-based crucible material that is especially useful for making crucibles for melting nickel base superalloys and cobalt superalloys in air, under vacuum, or under a protective atmosphere such as inert gas, although the invention can be practiced to make crucibles for melting other metals and alloys that include, but are not limited to, steel, iron based alloys, and aluminum. Sintered (fired) ceramic crucibles in accordance with the invention exhibit improved resistance to thermal shock when heated in use for melting a metal or alloy to over 1100 degrees C.

An illustrative embodiment of the invention provides a crucible material whose chemical composition consists essentially of, in weight %, before sintering, about 93.5% to about 97.5% ZrO₂, about 0.2% to about 1.0% MgO, about 1.0% to about 3.0% SiO₂, and about 1.5% to about 2.5% Y₂O₃. The crucible material comprises, before sintering, respective dry particles of ZrO₂, MgO, and Y₂O₃ and a SiO₂-bearing material. For example, SiO₂-bearing particles can be selected from the group consisting of silica, a silicate of zirconium (e.g. ZrSiO₄ which comprises ZrO₂+SiO₂), a silicate of magnesium, and a silicate of yttrium and combinations thereof. The SiO₂ content (weight %) of the crucible material is calculated based on the SiO₂ content of the particular silicate employed.

The zirconia (ZrO₂) particles preferably are present in a plurality of particle sizes wherein a majority of the ZrO₂ particles have a particle diameter size of about 44 microns and greater. For purposes of illustration, the ZrO₂ particles include about 38 weight % of particles of about 150 to about 420 microns particle diameter size, about 17 weight % of particles of about 44 to about 150 microns particle diameter size, and about 45 weight % of particles less than about 44 microns particle diameter size.

The MgO particles, SiO₂-bearing particles, and Y₂O₃ particles preferably each are present as particles of less than about 44 microns particle diameter size to increase reactivity of the powders during firing.

In practicing the invention, the ZrO₂ particles, MgO particles, SiO₂-bearing particles, and Y₂O₃ particles are dry mixed for a suitable time to form a homogenous dry mixture. A conventional V-Cone mixer available from Patterson-Kelly Co., or any other suitable dry mixer, can be used to this end.

The dry mixture then is mixed with a suitable binder comprising, for example, a controlled amount of water and a binding agent such as gum arabic, for a suitable time to form a homogenous wet mixture having a desired water content. For purposes of illustration and not limitation, the binder comprises 3 weight % gum arabic and balance water. The binder can be present in an amount of 5 weight % of the wet mixture. A conventional MULLER mixer available from Simpson Co., or any other suitable mixer, can be used to mix the liquid binder and dry mixture to form the wet mixture. The wet mixture then is passed through a vibratory SWECO separator (model No. 1S18S33 from Sweco, Inc. Los Angeles, Calif.) with 24 mesh (Tyler) screen to remove agglomerates greater than 24 mesh (approximately 170 microns), permitting material finer than 24 mesh to pass through and be used for pressing. For purposes of illustration and not limitation, the moisture content of the wet mixture is within a selected range of about 1.4 to about 1.9 weight % water.

The wet mixture then can be pressed using conventional molding equipment to form a free-standing green (unfired) crucible body.

The molded crucible body can be sintered (fired) at a high temperature above 1650 degrees C.) in air, preferably in the range of 1670 to 1700 degrees C., to form a sintered (fired) crucible, that is ready for use to melt a metal or alloy or to hold a molten metal or alloy and that exhibits improved resistance to thermal shock when the crucible temperature is over 1100 degrees C. When the crucible material is sintered as described, the Y₂O₃ component is soluble in the ZrO₂ component, and the crucible composition corresponds to that of the crucible particulate material set forth above.

The following Examples are offered to further illustrate but not limit the invention.

### EXAMPLES

Test bars and crucibles were made pursuant to embodiments of the invention. For example, the following test bar materials expressed in weight percent as dry particles were tested:

| | ZrO₂ | | | |
|---|---|---|---|---|
| | monoclinic | MgO | SiO₂ | Y₂O₃ |
| 1 | 95.2 | 0.8 | 2.0 | 2.0 |
| 2 | 94.5 | 0.8 | 2.2 | 2.5 |

The monoclinic ZrO₂ particles comprised 38 weight % of particles of about 150 to about 420 microns particle diameter size, 17 weight % of particles of about 44 to about 150 microns particle diameter size, and 45 weight % of particles less than about 44 microns particle diameter size. The MgO particles, SiO₂ particles, and Y₂O₃ particles each were present as particles of less than about 44 microns particle diameter size.

The ZrO₂ particles, MgO particles, SiO₂ particles, and Y₂O₃ particles were dry mixed using a conventional V-Cone mixer for 30 minutes to form a homogenous dry mixture. The dry mixture then was mixed with a binder (3 weight % gum arabic and balance water) for 45 minutes to form a homogenous wet mixture. The binder comprised 5 weight % of the wet mixture. A conventional MULLER mixer was used. The wet mixture then was seived to remove agglomerates as described above.

The wet mixture then was pressed in a conventional hand-activated press to make bar-shaped specimens (dimensions of 6 inches length by ½ inch width by ¼ inch thickness) for 3-point bend tests to determine modulus of rupture (MOR). The bar specimens were split into two groups. One group was tested after being fired at a temperature of 1680 degrees C. in air for 120 minutes and cooled to ambient temperature. The other group of bar specimens was tested after being similarly fired at 1680 degrees C. in air for 120 minutes and cooled followed by further reheating to 1400 degrees C. in air and then quenching in water. A reheated/quenched specimen was considered to have good thermal shock resistance if its MOR value was equal to or greater than that exhibited by the fired-only specimens.

The MOR values for reheated/quenched test bars made of material 1 exhibited a MOR value that was equal to or greater than that of fired test bars made of the same material 1. The MOR values for reheated/quenched test bars made of material 2 exhibited a MOR value that was equal to or greater than that of fired test bars made of the same material 2. The wet mixture of material 2 also was pressed in a conventional isopress molding machine to form a free-standing molded, green crucible comprising a right-cylinder with a closed end. The molded, green crucible body was sintered (fired) at a temperature of 1680 degrees C.) in air for 120 minutes. Test crucibles made of material 2 survived 2 to 3 times more pours of molten nickel base superalloy without cracking than conventional production crucibles.

Although the invention is described above with respect to certain embodiments, those skilled in the art will appreciate that modifications and changes can be made therein without departing from the spirit and scope of the invention set forth in the appended claims.

We claim:

1. A crucible material whose chemical composition consists essentially of, in weight %, about 93.5% to about 97.5% ZrO₂, about 0.2% to about 1.0% MgO, about 1.0% to about 3.0% SiO₂, and about 1.5% to about 2.5% Y₂O₃.

2. The material of claim 1 wherein the SiO₂ is present as SiO₂-bearing particles.

3. The material of claim 1 wherein the SiO₂-bearing particles are selected from the group consisting of silica, a silicate of zirconium, a silicate of magnesium, and a silicate of yttrium.

4. The material of claim 1 wherein said ZrO₂ is present as ZrO₂ particles that include about 38 weight % of particles of about 150 to about 420 microns particle diameter size, about 17 weight % of particles of about 44 to about 150 microns particle diameter size, and about 45 weight % of particles less than about 44 microns particle diameter size.

5. The material of claim 1 wherein said MgO is present as MgO particles having a particle diameter size of less than about 44 microns.

6. The material of claim 2 wherein said SiO₂-bearing particles have a particle diameter size of less than about 44 microns.

7. The material of claim 1 wherein said Y₂O₃ is present as Y₂O₃ particles having a particle diameter size of less than about 44 microns.

8. A crucible made from the crucible material of claim 1.

9. The crucible of claim 8 which is fired at elevated temperature.

10. A method of making a crucible, comprising mixing a binder with the crucible material of claim 1 to provide a wet mixture, forming said wet mixture to have a crucible shape, and firing the crucible shape.

11. The method of claim 10 wherein the binder comprises gum arabic and water.
